(19) United States
(12) Patent Application Publication
(10) Pub. No.: US 2006/0171392 A1
(43) Pub. Date: Aug. 3, 2006

(54) SYSTEM AND METHOD FOR EXTRACTING AND ROUTING AUDIO-VISUAL PROGRAMS FROM TRANSPORT STREAM PACKETS

(76) Inventors: Teng-Yi Jen, Tai-Nan City (TW); Kuo-Chung Gan, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/906,005

(22) Filed: Jan. 30, 2005

(51) Int. Cl. H04L 12/56

(52) U.S. Cl. 370/392

(57) ABSTRACT

A system and method for extracting and routing audio-visual programs from transport stream packets includes a program identifier (PID) distributor capable of extracting program specific information (PSI) from the transport stream packets, a plurality of process paths each including an audio video stream encapsulate circuit (AVSEC) capable of encapsulating each packet of each Audio-Visual (AV) program in data packets of a predetermined format, a switching device capable of routing the encapsulated AV program packets to user pathways, and a processing device capable of parsing the PSI to identify AV programs therein and configuring the other routing system elements. Dynamic management of data flow is enabled, thus data routing is made more efficient and is readily customized to the needs of user networks at any time, and significantly, because AV programs are processed in parallel by dedicated processing paths, processing device burden and memory usage are reduced.

### BACKGROUND OF INVENTION

1. Field of the Invention

The present invention is related to an Audio-Visual (AV) programs transmission system, and more particularly, to the receipt of transport stream (TS) packets, extraction of AV programs from transport stream packets and routing of the extracted AV programs to multiple user networks.

2. Description of the Prior Art

In situations where AV programs are transmitted via environments where errors may occur or be induced, for example, transfer via radio or long distance cable links (such as Digital Video Broadcasting (DVB) or the Institute of Electrical and Electronics Engineers (IEEE) 1394 protocol), a so-called transport stream (TS) method is utilized. Under TS methodology, an AV program is arranged into fixed-length data packets prior to transmission. This not only makes it easier (as compared to methodologies using variable-length data packet schemes) for hardware to process the data, but also allows easier implementation of error correction schemes.

Please refer to FIG. 1, which is a schematic representation of a TS data packet 10. It can be seen that the TS data packet 10 comprises a four byte header 11 and 184 payload bytes 12. The TS header 11 can be broken down further as illustrated in FIG. 2, in which the identification number for identifying the TS packet is the same as in FIG. 1. FIG. 2 shows the TS header 11 and its constituent parts: a synchronization byte 21, a number of flag bits 22, Program Identifier (PID) 23, scramble key 24, adaptation flag 25 and counter 26. Of these elements, only the PID 23 is significantly related to the present invention and is expanded upon below. Other elements are included only to set the PID 23 in a broader context and are not described further herein.

Particularly in the case of DVB, a transport stream or channel may contain several programs, these having been multiplexed and transmitted concurrently. Hence, a complex task is faced by any device receiving TS data, that being to identify and re-concatenate the original AV programs (and related audio/video streams) from the incoming multiplexed transport stream. The complexity of this task often requires a dedicated processing unit to be included in a receiving device, or else demands a large resources overhead from a primary processing unit. In cases where the receiving device is integral to, or hosted by, for example, a computing device, the burden of receiving device processing would fall upon the central processor unit (CPU) of the host device.

An example of a prior art device utilizing the abovementioned system is a television set top server. FIG. 3 is a block schematic diagram depicting a television ‘set top box’ server system and user networked devices 30, capable of receiving a multi-program transport stream or channel, de-multiplexing the transport stream data to re-concatenate the AV program/programs, and addressing and distributing the AV program packets to downstream user devices. The television set top server comprises a set top box server 300, housing a DVB tuner 301 for receiving an incoming multi-program signal 35, a demodulator 302 for separating the carrier wave from the multi-program transport stream, a de-multiplexer (DEMUX)/Program Identifier (PID) filter 303 for separating the various AV programs within the multi-program transport stream, and for extracting PID data for each data packet, a PID to Internet Protocol (IP) address mapping unit 304 for translating the PID data of each packet into the IP addresses of target network devices, a packet converter 305 for converting packet format (from, for example Moving Picture Expert Group 2 (MPEG2) format, to IP packet format), and a router 306 for routing the IP packets to an appropriate network or network enabled devices 31˜34.

The simplified overview above, belies the complexity of such devices as the set top box server 300, the functions carried out from the de-multiplexer (DEMUX)/PID filter 303 to Router 306 are complex and require the allocation of memory space and processing power to filter out AV programs, to find an IP address based on PID in a lookup table, to encapsulate AV programs into IP packets, and to deliver IP packets to a user network by router. Such behavior needs a lot of data movement in allocated memory and suitable processing power to deal with the above tasks (303˜306). So, devices such as the set top box server 300 generally have an integral central processor unit (CPU) or micro-controller of reasonable power and a reasonable memory space. Therefore here exists an efficient system and method to reduce the memory space and CPU processor power requirement. Furthermore the system offers a plurality of AV program extracting and routing paths with high throughput capability.

FIG. 4 is a block diagram illustrating the make up of a typical multi-program transport stream 40. It can be seen from FIG. 4 that multiple AV programs are conveyed within the TS by the multiplexing of the various AV program packets 401˜412 (multiplexed prior to transmission). Included is a data packet 401 containing a Program Association Table (PAT) 42. The PAT 42, along with two other tables, the Program Map Table (PMT), of which there is one for each program carried by the transport stream 40, in this example AV program A PMT 43 and AV program B PMT 44, the Network Information Table (NIT—not shown), and Conditional Access Table (CAT—not shown), make up what is known as Program Specific Information (PSI). The CAT is used for conditional access control, e.g., for pay-per-view programs, while the NIT may be parsed for user or remote CPU interrogation. NIT and CAT are not relevant to the present invention and hence are not further explained in this disclosure. The PAT 42 is the key to de-multiplexing the transport stream 40, as it contains information on the location of the other tables, most significantly the PIDs of the Program Map Tables (PMTs) 43˜44 for each of the AV programs (A and B in this example. The PMTs 43˜44 are important because they in turn contain information relating to which PIDs are used to identify the discrete audio and video packets that constitute the AV programs. The PAT, therefore, appears in the transport stream at regular intervals.

Within the transport stream, a PID with a reserved value of 0 indicates a data packet that contains a PAT. The PAT associates a particular PID value with each program that is currently present in the transport stream. This PID value in turn identifies the PMT for that particular program. Initially, for example upon start-up or acquiring a new channel, in the case of the device of FIG. 3, the de-multiplexer (DEMUX)/PID filter 303 filters the PID 0 packets in the transport stream to acquire the PAT therein. This being done, a menu of channel content is available to a user and/or a controlling device. The user or controlling device may select one or more of the available programs, hence the de-multiplexer (DEMUX)/PID filter 303 must filter the PMTs of the selected programs based on the corresponding PIDs and construct a PMT for each program from the relevant PMT packets.

Referring again to FIG. 4, it should be noted that the AV programs can be further broken down into not only video and audio streams, but also Program Clock Reference (PCR) streams. The PCR streams contain time stamp information for enabling a user device to correctly re-concatenate and synchronize the audio and video streams of the relevant program. Hence in FIG. 4, the PMTs 43˜44 contain PID information for each constituent ‘sub-stream’ of each AV program, i.e. PMT 43 constituent video stream 431, audio stream 432 & PCR 433 for AV program A, and PMT 44 constituent video stream 441, audio stream 442 & PCR 443 for AV program B.

The overview above, hints at the complexity of such devices as the set top box server 300, the functions carried out by the de-multiplexer (DEMUX)/PID filter 303 for example, are complex and require the allocation of memory space and processing power. Therefore, devices such as the set top box server 300 generally have an integral central processor unit (CPU) or micro-controller of reasonable power and a reasonable memory space. With such devices being employed increasingly in the home, consumer pressure is driving cost reduction requirements in the field of manufacturing; realization of cost reductions in a complex product may reasonably come from a simplification in the structure, hence there is a need then, for a simplified device and method for parsing program specific information from transport stream packets, de-multiplexing, re-concatenating and distributing AV programs.

### SUMMARY OF INVENTION

A routing system for identifying AV programs from transport stream packets and routing the identified AV programs includes a program identifier (PID) distributor with a plurality of output ports, a plurality of process paths, each process path of the plurality of process paths having a first end connected to an output port of the PID distributor and including an audio video stream encapsulate circuit (AVSEC), a switching device connected to a second end of each process path of the plurality of process paths, the switching device having a plurality of input/output ports, and a processing device having connections to the PID distributor, the AVSEC of each process path and the switching device.

A method for identifying and routing AV programs in the above routing system includes extracting program specific information (PSI) from transport stream packets, the transport stream packets containing a plurality of AV programs, parsing the PSI to identify each AV program of the plurality of AV programs, and routing each identified AV program of the plurality of AV programs through one or more process paths of a plurality of process paths. Also, in each process path of the plurality of process paths, encapsulating each packet of each identified AV program in data packets of a predetermined format to form encapsulated AV program packets, and routing the encapsulated AV program packets to a user pathway.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic representation of a Transport Stream (TS) data packet.

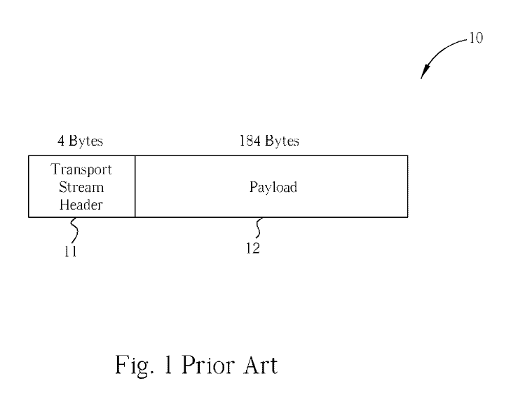

FIG. 2 is a block diagram showing a TS header and its constituent parts.

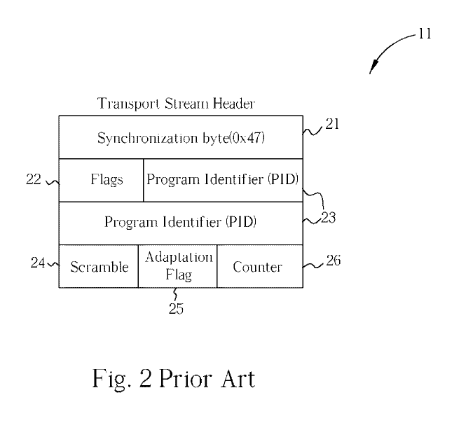

FIG. 3 is a block schematic diagram depicting a television ‘set top box’ server system according to the prior art.

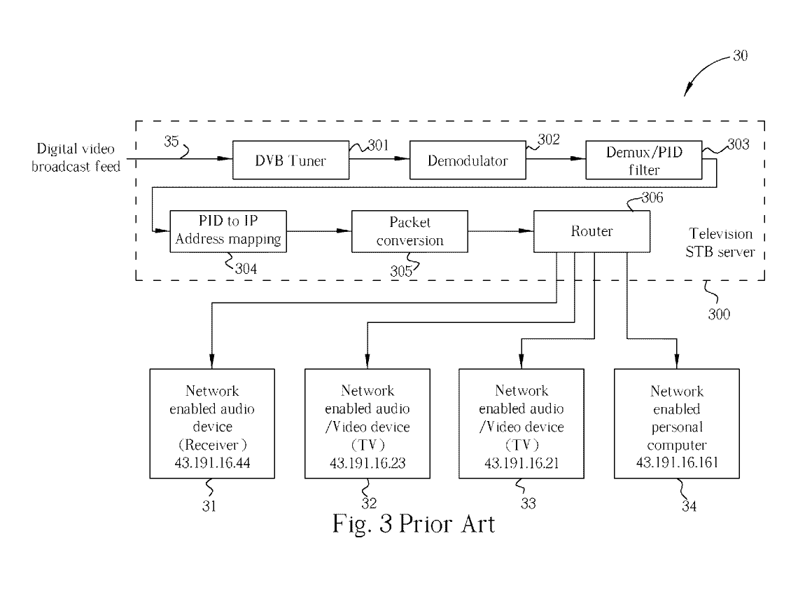

FIG. 4 is a block diagram illustrating the make up of a typical multi-program transport stream according to the prior art.

FIG. 5 is a block schematic diagram of a preferred embodiment of the present invention device.

FIG. 6 is a block diagram representing the Audio-Video (AV) packet distribution process of the present invention Program Identifier (PID) distributor.

FIG. 7 is a block diagram representing the AV packet encapsulation process of the present invention AV Stream Encapsulate Circuit (AVSEC).

### DETAILED DESCRIPTION

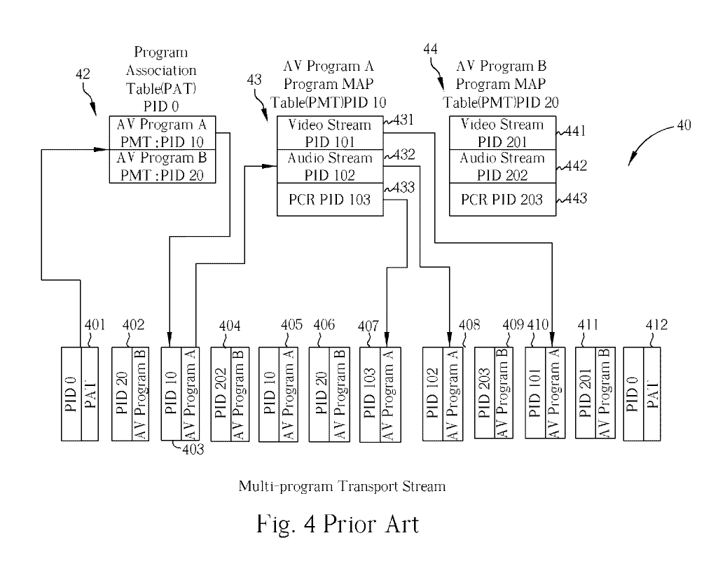

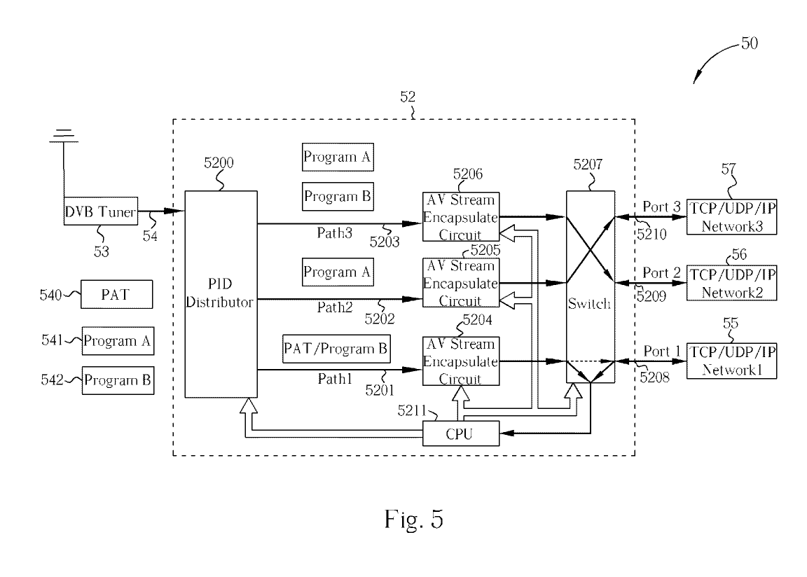

Please refer to FIG. 5, which is a block schematic diagram of a preferred embodiment of the present invention device for recognizing, re-packetizing and distributing Audio-Visual (AV) programs from transport stream (TS) packets. The preferred embodiment example shown in FIG. 5 has a Digital Video Broadcast (DVB) tuner 53, although this may be replaced by a Moving Picture Expert Group (MPEG) encoder, or other multi-program transport stream source, in alternative embodiments. The DVB tuner 53 receives and de-modulates incoming DVB signals and outputs a multi-program transport stream 54. The multi-program transport stream 54 comprises two AV programs, Program A 541 and Program B 542, the data of which will be packetized in 188-byte data packets, these data packets occurring in a mixed order within the transport stream (as in FIG. 4) according to the multiplexing strategy employed by the multiplexer of the transmitting station (not shown).

Also included in the transport stream is a Program Association Table (PAT) 540, which as described above, contains information on the location of other tables, most significantly the Program Map Table (PMT) for each of the AV programs.

The core of the present invention embodiment 50 is a Program Specific Information (PSI) recognition, de-multiplexing and distribution engine 52. The (PSI) recognition, de-multiplexing and distribution engine 52 comprises a Program Identifier (PID) distributor 5200, three parallel processing paths, Path1 (5201), Path2 (5202) and Path3 (5203), the processing paths 5201˜5203 in turn each including an AV Stream Encapsulate Circuit (AVSEC), 5204˜5206 respectively, a network routing switch 5207 having three external input/output ports, Port1 (5208), Port2 (5209) and Port3 (5210), and an integral Central Processor Unit (CPU) 5211. The processing capacity provided by the integral CPU 5211 may also be provided by a suitable micro-controller, custom processing device or host device/remote CPU in alternative embodiments.

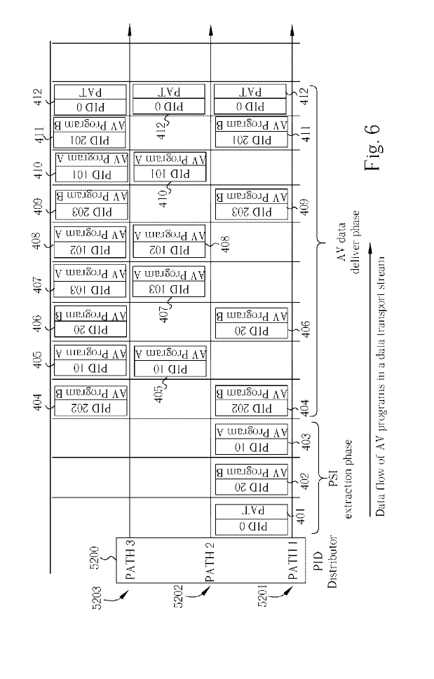

The multi-program transport stream 54 output by the DVB tuner 53 is input to the PID distributor 5200. The task of the PID distributor 5200 is to separate the various programs 541˜542 within the multi-program transport stream 54 and route each program to a predetermined processing path, i.e. either Path1 (5201), Path2 (5202) or Path3 (5203), these processing paths being connected to output ports of the PID distributor 5200. The routing assignment for each program is decided by the CPU 5211, i.e. the PID distributor 5200 acts according to configuration passed down by the CPU 5211. However, before the PID distributor 5200 can recognize and differentiate between the various AV programs 541˜542, it must first extract the PSI from the transport stream packets. As discussed in the description of the prior art above (please refer to FIG. 4), data packets within the transport stream packets having PID values of 0 contain the Program Association Table (PAT). The PAT is repeated at intervals in the transport stream, hence many instances of the same data are available to the PID distributor 5200. The PID distributor's 5200 first task then, is to filter the transport stream 54 for data packets having PID values 0, and then to route the extracted PAT to the CPU 5211 for parsing. In the preferred embodiment example shown, Path1 (5201) is the default process path for this procedure, however, any other process paths or indeed a dedicated process path may be utilized in alternative embodiments. This initial routing is configured by the CPU 5211 at start-up or whenever a new channel is acquired. Upon receiving an instance of the PAT (540), the CPU 5211 parses the information therein in order to determine the PIDs used for identifying the Program Map Tables (PMTs) of the various programs. The CPU 5211 then configures the PID distributor 5200 to filter the transport stream 54 for PMTs, the extracted PMTs in turn being routed to the CPU 5211 in the same way as the extracted PAT. The CPU 5211 can then parse the PMT information to determine which PIDs are used within the transport stream to identify the audio, video and PCR stream packets of the individual programs. Once this information has been successfully parsed, the CPU 5211 configures the PID distributor 5200 to recognize the audio, video and PCR stream packets of the individual programs 541˜542, and also to route the above stream packets to specific process paths. At this point, Path1 (5201) becomes available and may be designated to carry one or more AV program(s), as its initial tasking of conveying extracted PSI to the CPU 5211 is completed. In the preferred embodiment example illustrated by FIG. 5, once all required PSI has been parsed, Path1 (5201) is configured to carry Program B 542 AV program packets. Note: this will include audio, video and PCR stream packet filtering by using Program B PIDs. Path2 (5202), is configured to carry Program A 541 AV program packets, and likewise, this will include audio, video and PCR stream packet filtering by using Program A PIDs. Path3 (5203), is configured to carry both Program A 541 and Program B 542 AV program packets, and once more, this will include audio, video and PCR stream packet filtering by using Program A and Program B PIDs. The above is illustrated in more detail by FIG. 6, which expands upon the AV packet distribution process of the present invention PID distributor using like reference numbers from FIGS. 4 & 5. In FIG. 6, the transport stream (TS) 40 of FIG. 4 is shown being distributed into paths 1˜3 (5201˜5203) of FIG. 5. There are two phases to this process: first, the PSI extraction phase, which comprises the delivery of PAT 401 and PMT 402˜403 on PATH1, followed by the AV data delivery phase, beginning with the delivery of TS packet 404 containing Program B PID 202 on PATH1 and PATH3 and continuing rightward from there. It can be seen that Path1 (5201) carries the initial PAT 401 which will be encapsulated by AVSEC 5204 and sent to CPU 5211 thru switch 5207 with default configuration process path. The CPU 5211 parses the received PAT 401 to find out the PMT's PID of AV program A&B (refer FIG. 4 PAT table 42). Then the CPU 5211 configures the PID distributor 5200 to identify PMT tables 43˜44 and distribute TS packets 402˜403 to Path1 (5201). Then the PMT 402˜403 will be routed to CPU 5211 and parsed by CPU 5211 the same as PAT 401 described above. After the Program Specific Information (PSI) extraction process, the CPU 5211 has related stream PIDs of AV programs A&B. From user configuration, CPU 5211 configures the PID distributor to identify the TS packets of the AV programs A&B 541˜542 and to distribute AV program B 542 to Path1 (5201), AV program A 541 to Path2 (5202), AV program A&B 541˜542 to Path3 (5203). Hence only data packets with a program B PID (404, 406, 409, 411, 412 in this example), appear in Path1 (5201) and route to Network1 55 thru Switch 5207. Similarly, only data packets with a program A PID (405, 407, 408, 410, 412 in this example), appear in Path2 (5202) and route to Network3 57 thru Switch 5207. Data packets with both program A and program B PIDs (404˜412 in this example), appear in Path3 (5203) and route to Network2 56 thru Switch 5207.

Referring again to FIG. 5, the next consecutive process along each of the parallel process paths 5201˜5203 and the task of the each respective AVSEC 5204˜5206, is to encapsulate the AV program data packets in Internet Protocol (IP) ‘shells’ or ‘carrier’ packets. This is necessary because while the AV program data packets are meaningful to the user devices for which they are targeted, AV program data packets are generally not compatible with the network data transport system used to convey the packets to said user devices. Here, an IP may mean a transmission control protocol/internet protocol (TCP/IP) format or a user datagram protocol/internet protocol (UDP/IP) format.

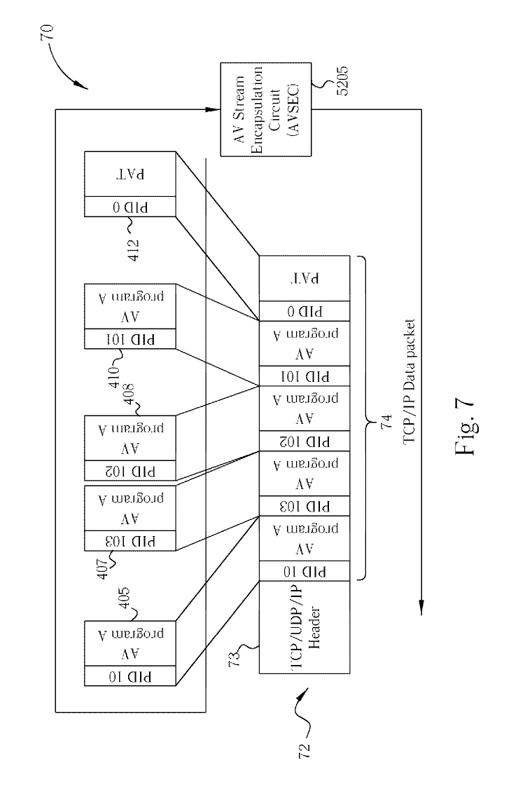

Like the PID distributor 5200, the AVSECs 5204˜5206 are configured by the CPU 5211 and address each IP packet with the address of a user device (which may be a network enabled device), accordingly. Each of the AVSECs 5204˜5206 dynamically encapsulates data packets by conversion into the payload data of a network protocol data packet. That is, the AVSECs 5204˜5206 will append each series of data packets, to an appropriately addressed TCP/IP header to form a TCP/IP network packet. FIG. 7 represents a TCP/IP data packet composition process 70, taking place in an AVSEC which, in this example, is the Path2 AVSEC 5205 of FIG. 5. Accordingly, the TS data packets streaming into the Path2 AVSEC 5205 are the Path2 data packets 405, 407, 408, 410 & 412 depicted in FIG. 6, hence like reference numbers have been retained. As the data packets 405, 407, 408, 410 & 412 arrive at the AVSEC 5205, they are packaged as the payload 74 of a TCP/IP data packet 72, being appended to a TCP/IP header 73. The payload 74 and the TCP/IP data packet 72 is transmitted along Path2 onward to the network routing switch 5207 (FIG. 5 refers).

Finally, the network routing switch 5207, also having been configured by the CPU 5211, routes the output of the AVSEC 5204˜5206 to the appropriate predetermined input/output port(s), i.e. either Port1 (5208), Port2 (5209), Port3 (5210) or combination thereof.

In the preferred embodiment illustrated by FIG. 5, the input/output ports, Port1˜Port3 (5208˜5210) are each connected to a network, Network1 (55), Network2 (56) and Network3 (57) respectively. Here, Network1 (55) has the additional role of hosting a network controller (not shown). Network data traffic assignments are decided by the network controller, hence the network routing switch 5207 is configured to allow Control Information Packets (CIPs) issued by the network controller to reach the CPU 5211. The CPU 5211 will in turn configure the PID distributor 5200, the AVSECs 5204˜5206 and the network routing switch 5207 upon receiving a CIP to direct output to the networks accordingly. Furthermore, dynamic adjustment is allowable, i.e. the network controller is not only able to influence data traffic routing at start-up or channel acquisition, but also on-the-fly at any time. As an additional control refinement, the network controller may also read the current data traffic routing status from the preferred embodiment device.

In an alternative embodiment, the network routing switch 5207 may be further simplified by hardwiring, for example, Path2 (5202) and Path3 (5203) AVSEC outputs directly to Port2 (5209) and Port3 (5210) respectively, but retaining the Path1 (5201) arrangement for initially routing PSI to the CPU 5211. This is practicable as long as the number of ports offered for network connection does not exceed the number of process paths, in which case the PID distributor 5200 can also manage switching functions.

It is an advantage of the present invention that dynamic management of the transport stream to user network data flow is enabled, and may be supervised by a network controller or present invention device integral or remote processor. Data routing is therefore made more efficient as it can be based upon network availability and bandwidth, and readily customized to the needs of user networks at any time. Notably, because the present invention utilizes multiple process paths, selection of programs for further propagation is made close to the transport stream input end of the device, thus unselected programs in the transport stream are not processed further, i.e. the present invention only processes data that is strictly necessary. This approach saves memory space, complexity and improves efficiency compared to systems where all transport stream content is processed, required content only being selected at the output end of the device, thus leading to the processing of ‘un-necessary’ data.

It is a further advantage of the present invention that because of the ‘processing engine’ approach, AV programs can be processed in parallel by the dedicated AVSEC in each processing path, rather than sequentially by either a single path or device with a similar function, or by burdening, for example, a CPU and large amounts of memory.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A routing system for distributing AV programs comprising:
a program identifier (PID) distributor with a plurality of output ports;
a plurality of process paths, each process path of the plurality of process paths having a first end connected to an output port of the PID distributor and including an audio video stream encapsulate circuit (AVSEC);
a switching device connected to a second end of each process path of the plurality of process paths, and having a plurality of input/output ports; and
a processing device having connections to the PID distributor, the AVSEC of each process path and the switching device.

2. The routing system of claim 1, wherein the PID distributor is capable of receiving a plurality of transport stream packets, being configured by a routing requirement of the processing device, extracting program specific information (PSI), identifying AV programs in the plurality of transport stream packets according to the routing requirement and distributing the AV programs to process paths according to the routing requirement.

3. The routing system of claim 2, wherein the AVSEC included in each process path of the plurality of process paths is capable of being configured by the routing requirement of the processing device and encapsulating each packet of each AV program routed along each respective process path, in data packets of a predetermined format to form encapsulated AV program packets according to the routing requirement.

4. The routing system of claim 1, wherein the switching device is capable of being configured by a routing requirement of the processing device and routing an output of each process path of the plurality of process paths to a user pathway according to the routing requirement.

5. The routing system of claim 4, wherein the user pathway is a transmission control protocol/internet protocol (TCP/IP) network or a user datagram protocol/internet protocol (UDPIP) network.

6. The routing system of claim 1, wherein the processing device is capable of parsing program specific information in a plurality of transport stream packets and configuring the PID distributor, each process path of the plurality of process paths, the AVSEC of each process path, and the switching device with a routing requirement.

7. A method for identifying and routing AV programs comprising the following steps:
(a) extracting program specific information (PSI) from a plurality of transport stream packets, the plurality of transport stream packets containing a plurality of AV programs;
(b) parsing the PSI to identify each AV program of the plurality of AV programs;
(c) routing each identified AV program of the plurality of AV programs through one or more process paths of a plurality of process paths;
(d) in each process path of the plurality of process paths, encapsulating each packet of each identified AV program, in data packets of a predetermined format to form encapsulated AV program packets; and
(e) routing the encapsulated AV program packets to a user pathway.

8. The method of claim 7, further comprising the following steps:
(f) configuring a routing system with a routing requirement for PSI; and
(g) receiving a demodulated plurality of transport stream packets from a receiving device.

9. The method of claim 8, wherein step (g) is receiving a plurality of demodulated transport stream packets from a digital video broadcast tuner.

10. The method of claim 8, wherein step (f) comprises configuring a routing system with a routing requirement for PSI upon system start-up or channel acquisition.

11. The method of claim 7, wherein step (a) comprises extracting a program association table (PAT) from the plurality of transport stream packets, and extracting a program map table (PMT) for each of the plurality of AV programs from the plurality of transport stream packets according to the PAT.

12. The method of claim 7, wherein step (c) comprises configuring a routing system with a routing requirement and routing each identified AV program of the plurality of AV programs through one or more process paths of a plurality of process paths, according to the routing requirement.

13. The method of claim 12, further comprising configuring the routing system with the routing requirement according to a control information packet (CIP).

14. The method of claim 13, further comprising reconfiguring the routing requirement of the routing system according to the CIP at any time.

15. The method of claim 13, further comprising allowing issuance of the CIP by a source external to the routing system and allowing the source to interrogate a status of the routing system.

16. The method of claim 7, wherein in the predetermined format of step (d) is a transmission control protocol/internet protocol (TCP/IP) format or a user datagram protocol/internet protocol (UDPIP) format.

17. The method of claim 7, wherein step (d) further comprises addressing each encapsulated packet of each AV program with the address of a user device.
